(19) United States
(12) Patent Application Publication
(10) Pub. No.: US 2015/0104760 A1
(43) Pub. Date: Apr. 16, 2015

(54) TOUCH SCREEN SCHOLASTIC TRAINING SYSTEM

(71) Applicant: Edison Gauss Publishing Inc., West Linn, OR (US)

(72) Inventor: Scott D. Tepavich, West Linn, OR (US)

(73) Assignee: EDISON GAUSS PUBLISHING INC., West Linn, OR (US)

(21) Appl. No.: 14/507,449

(22) Filed: Oct. 6, 2014

Related U.S. Application Data
(60) Provisional application No. 61/890,978, filed on Oct. 15, 2013.

(51) Int. Cl. G09B 7/00; G09B 19/00; G06F 3/0482; G09B 23/00; G09B 23/06; G06F 3/0488; G09B 23/02; G09B 23/24

(52) U.S. Cl. CPC G09B 7/00; G09B 23/02; G09B 19/00; G09B 19/0061; G09B 19/0046; G09B 23/24; G09B 23/00; G09B 23/06; G06F 3/0488; G06F 3/0482
USPC 434/130; 434/362; 434/188; 434/169; 434/154; 434/298; 434/295; 434/300

(57) ABSTRACT

An interactive scholastic teaching device may use first and second portions of a touchscreen for presenting problems and receiving answers to the problems from a user. The first portion of a touchscreen display is used for presenting one or more scholastic problems for a user during a problem session, and the second portion of the touchscreen display is used for recording one or more traces manually input by the user on the second portion of the touchscreen display during the problem session. A memory stores the one or more traces. The touchscreen display may also include a third portion having one or more touch buttons structured to accept input from the user during the problem session, which may also be stored in the memory, and associated with the stored traces. The traces may be stored in image form, moving image form, or in data that may be re-created to form a moving image. Methods of performing scholastic training on a touch screen device as well as a computer readable medium containing program instructions for causing a computing device to perform the methods of scholastic training are also set forth.

### CROSS REFERENCE TO RELATED APPLICATIONS

This application claims benefit of U.S. Provisional Application 61/890,978, filed Oct. 15, 2013, entitled METHOD AND SYSTEM FOR PRACTICING AND REVIEWING SCHOLASTIC PROBLEMS ON TOUCH SCREEN DEVICES, the contents of which are incorporated herein.

### FIELD OF THE INVENTION

This disclosure relates to systems for formative assessment, and more particularly, to systems for scholastic training using adaptive learning techniques.

### BACKGROUND

Educational software is used in a variety of personal, professional, and institutional environments where academic rigor is essential for learning. Conventional educational software provides subject matter progression tailored by teachers and oftentimes software is controlled by an algorithm to automatically adjust the level of problem difficulty for the student.

Reviewing progress by a student using conventional software proves difficult, as most programs simply provide a number or percentage of correctly answered problems for each problem set. Such reporting feedback does not allow, for example, a teacher to easily determine why a student may be struggling or is failing to progress on a particular topic.

Embodiments of the invention address these and other limitations of the prior art.

### SUMMARY OF THE DISCLOSURE

Embodiments of the invention are directed to an interactive scholastic teaching device, such as a touchscreen having a first portion and a second portion. The first portion of a touchscreen display is used for presenting one or more scholastic problems for a user during a problem session, and the second portion of the touchscreen display is used for recording one or more traces manually input by the user on the second portion of the touchscreen display during the problem session. A memory stores the one or more traces. The touchscreen display may also include a third portion having one or more touch buttons structured to accept input from the user during the problem session, which may also be stored in the memory, and associated with the stored traces. The traces may be stored in image form, moving image form, or in data that may be re-created to form a moving image. Methods of performing scholastic training on a touch screen device as well as a computer readable medium containing program instructions for causing a computing device to perform the methods of scholastic training are also set forth.

### BRIEF DESCRIPTION OF THE DRAWINGS

FIG. 1 is a process diagram illustrating an example topology of a scholastic training system according to embodiments of the invention.

FIG. 2 is a screenshot illustrating an example title screen and user select of the scholastic training system of FIG. 1.

FIG. 3 is a screenshot illustrating an example welcome screen and activity select of the scholastic training system of FIG. 1.

FIGS. 4A and 4B are screenshots illustrating an example practice select activity of the scholastic training system of FIG. 1.

FIG. 5 is a screenshot illustrating an example arithmetic problem and example student practice of the scholastic training system of FIG. 1.

FIG. 6 is a screenshot illustrating an example of reworking a problem according to the scholastic training system of FIG. 1.

FIG. 7 is a screenshot illustrating an example of correcting a problem according to the scholastic training system of FIG. 1.

FIG. 8 is a process diagram illustrating example logic used in progressing to more difficult concepts according to the scholastic training system of FIG. 1.

FIG. 9 is a process diagram illustrating example logic used to adjust difficulty levels in the scholastic training system of FIG. 1.

FIG. 10 is a screenshot illustrating example writing options for the scholastic training system of FIG. 1.

FIG. 11 is a screenshot illustrating an example eraser mode in the scholastic training system of FIG. 1.

FIG. 12 is a screenshot illustrating an example review activity according to the scholastic training system of FIG. 1.

FIG. 13 is a screenshot illustrating reviewing filtered daily practices according to the scholastic training system of FIG. 1.

FIG. 14 is a screenshot illustrating an example review session according to the scholastic training system of FIG. 1.

FIG. 15 is a screenshot illustrating an example practice problem review according to the scholastic training system of FIG. 1.

### DETAILED DESCRIPTION

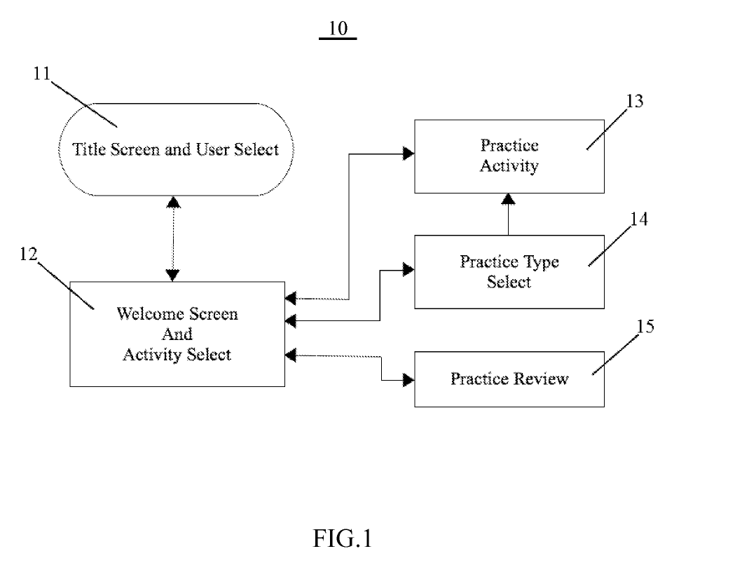

FIG. 1 is a process diagram illustrating an example topology of an example scholastic training system 10 according to embodiments of the invention. The example system 10 includes a title screen and user select operation 11, an activity selection operation 12, a practice activity operation 13, a practice type selection activity operation 14, and a reviewer activity operation 15. Other operations or flows are possible. Explanation and examples of interacting with the scholastic training system 10 are described in further detail below. The scholastic training system 10 may operate on, for example, a processor coupled to touchscreen device. The processor may be an Application Specific Integrated Circuit (ASIC), a Field Programmable Gate Array (FPGA), a special purpose microprocessor, or a particularly programmed general purpose microprocessor.

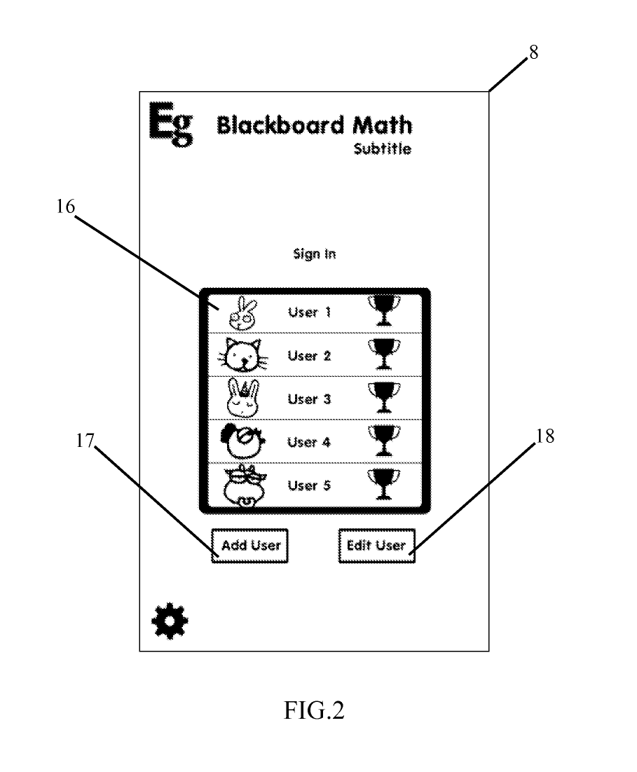

FIG. 2 is a screenshot illustrating an example title screen and user select 11. The title screen is illustrated on a display device 8, such as a touchscreen device. Examples of a touchscreen display device 8 include tablets, laptop computers, handheld computers and smart phones. A user interacting with the title screen and user select 11 shown on the display device 8 is presented with a user selection list 16, an add user selection 17, and an edit user selection 18. In operation, a user selects his or her user name from a list of user names 16 by touching the touchscreen display device 8 on the desired name. If the user is a new user, or if the user information has changed or was entered incorrectly, then the user may add or edit a user accordingly using the appropriate selection.

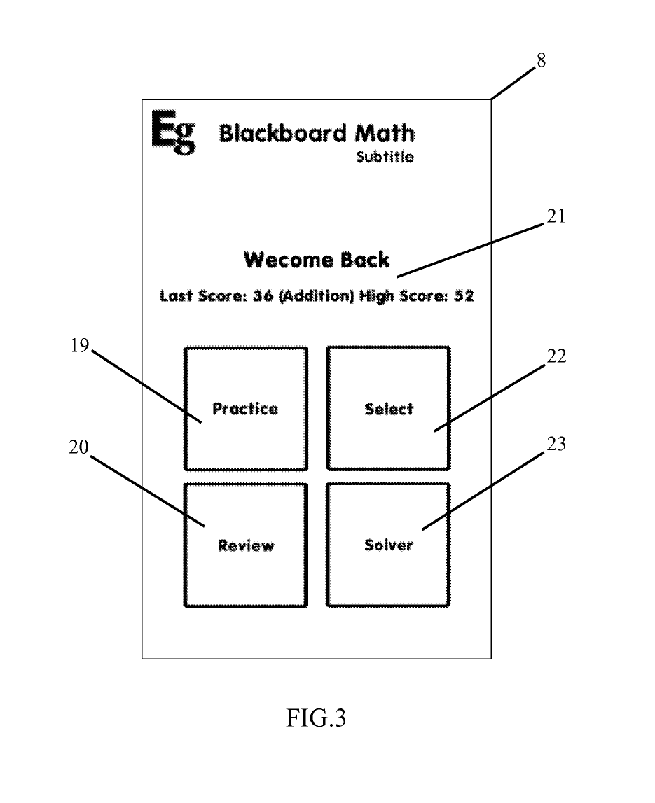

FIG. 3 illustrates an example welcome screen and activity selection activity 12 for the scholastic training system 10. The activity may include, for example, starting a configured practice activity option 19, reviewing a completed practice reviewer activity option 20, and selecting a practice type and configuration activity option 22. A free draw selection 23 is also available.

In operation, with reference to FIGS. 2-3, the user is presented with a title screen and user selection options 11 upon start, as illustrated in FIG. 2. The user then selects a particular profile 16 and he or she is then presented a series of activities to select from in the welcome screen 12 of FIG. 3. The activity options include start practice 19, select practice 22, and review practices 20. The practice activity 13 (FIG. 1) loads the last selected/configured set of practice materials for the user to work through defined problem sets when the start practice button 19 on the touchscreen 8 is selected. The practice type select activity 14 (FIG. 1) allows the user to select and configure the available subject material practices when the select button 22 on the touchscreen 8 is selected. The user can configure and begin a practice immediately, or return to the welcome activity 12 and begin the practice by selecting the start practice activity option 19 (FIG. 3). The review activity 15 (FIG. 1) provides options for reviewing the user's previously saved work and performance when the review practices button 20 on the touchscreen 8 is selected.

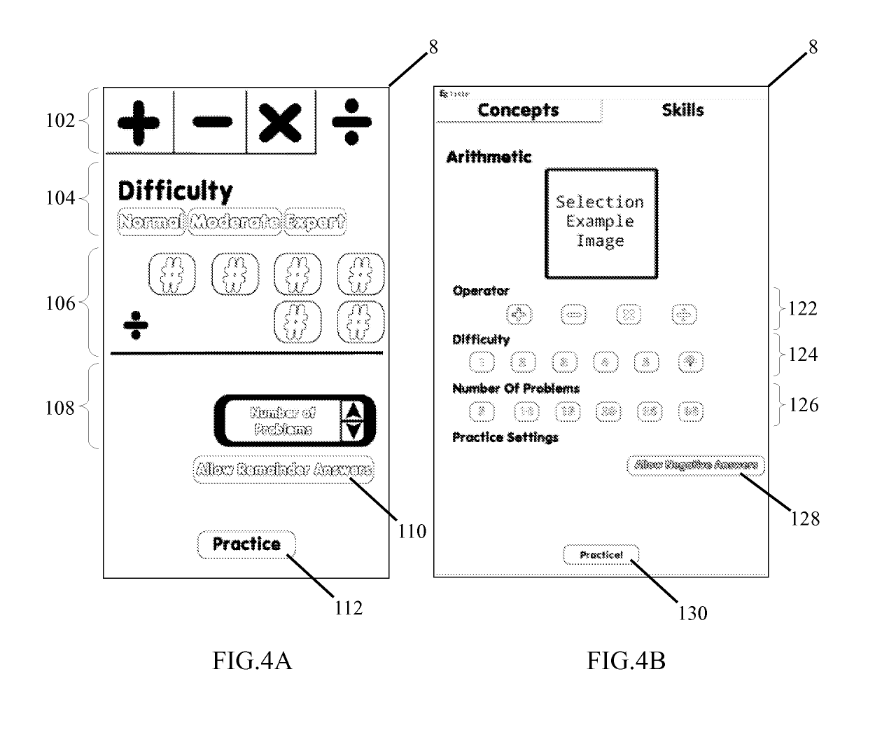

FIG. 4A is an example practice configuration menu for integer arithmetic, which may be one of the scholastic topics covered by embodiments of the invention. Other topics that may be presented through embodiments of the invention include chemistry, physics, biology, geography, foreign languages, writing, spelling etc. The menu of FIG. 4A presents options that allow the user to configure practice problems as well as an option to start a practice activity. Configuration practice problems may include the ability to select which operator the user wishes to practice (addition, subtraction, multiplication, division, etc.), by selecting one of the icons in an area 102 of the touchscreen 8. The user may configure the relative difficulty of the problems by making a selection in an area 104 of the touchscreen 8, and may configure the magnitude of the parameter numbers in an area 106. The user may configure the number of problems to practice in a session in an area 108. For integer division, a button 110 of the touchscreen 8 gives an option to allow remainders in an answer. Giving the option of including remainders or not gives the user the ability to tailor the practice problems to the skill level of the student. Finally, the user may begin the problem practice by selecting a practice button 112, which invokes the practice activity 13 of FIG. 1.

FIG. 4B is an example practice configuration menu for decimal arithmetic. A user would be presented with the menu of FIG. 4B by pressing the “+” button in area 102 of the screen illustrated in FIG. 4A. The menu of FIG. 4B presents options that allow the user to configure practice problems as well as an option to start a practice activity. Similar to the menu presented in FIG. 4A, problem configuration may include a choice to select which operators will appear in the practice problems in a section 122, the starting difficulty of the problems in a section 124, and the number of problems to practice within a given problem session in a section 126. A button 128 allows the problems to include negative answers. A button 130 allows the user to begin the problem practice, the pressing of which invokes the practice activity 13 of FIG. 1.

The subject material being presented to the student learner is organized into predefined levels of difficulty. Each difficulty level includes of multiple sets of problems, or types of problems, that represent an increasing level of difficulty and understanding of the conceptual data being covered. The number of problems in these sets, or difficulty progression sets, varies upon the subject material being presented. Along with the size of difficulty progression sets, the class defining this data also defines conceptual understanding metrics. These metrics include, for example, a minimum number of correct answers for a set to be graded as competent, the qualification of metrics for a solved problem to be considered proficient, and the minimum number of proficient answers for a set to be considered proficient. As illustrated in FIGS. 4A and 4B, the user has the option to change the starting difficulty level when configuring the practice in the practice select activity 14 (FIG. 1), and to select the number of problems for the practice sessions.

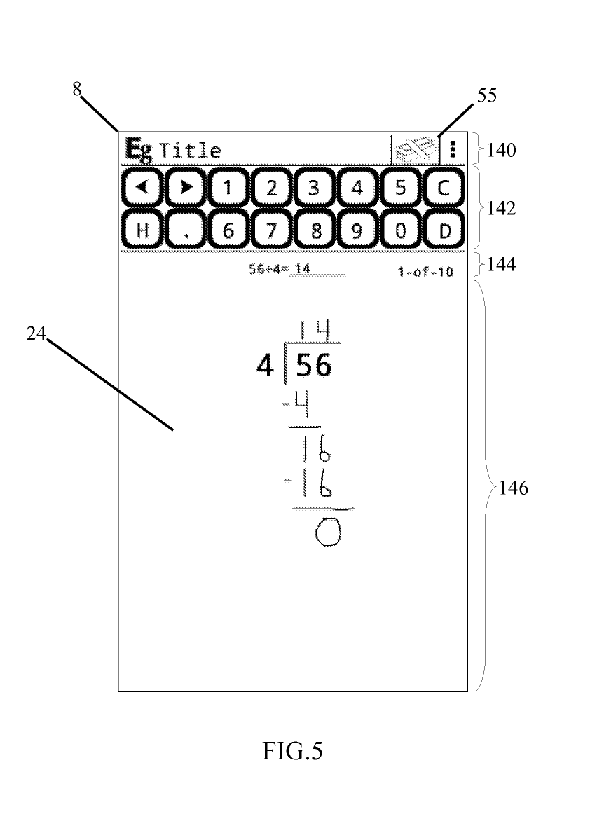

FIG. 5 illustrates an example arithmetic problem and related example student practice of the problem. A user is presented a problem screen such as illustrated in FIG. 5 by selecting the division symbol in the screen area 102 of FIG. 4A. In operation, the student is presented a math problem in a workspace 24 of the touchscreen device 8 in which the student may complete the problem by written hand. In this example the screen of the touchscreen device 8 is formed from several areas. A title area 140 statically displays text and an icon to indicate which function is shown on the screen. An area 142 includes touch buttons that allow the student user to make pre-defined inputs to the device. An area 144 of the screen presents the problem in a “text” format. An area 146 of the screen presents the problem in a “working” format, i.e., in a format that allows the user to work the problem in what is sometimes referred to as longhand, as well as a general workspace 24 that allows the user to interact with the problem. For example, in the workspace 24, the student may use his or her finger on the touch screen 8 on which the scholastic training system is operating, or the student may use a pencil stylus or other writing implement that works in conjunction with the particular device on which the system is running. The student has the ability to draw, or write, over and around the problem statement, and is also free to use the rest of the available space on the touchscreen to further work the problem out by hand. This format of the area 146 allows the student to interact with the presented problem in the natural manner they would interact on paper. The markings of the student are saved to memory of the touchscreen device 8 when the student finishes the problem. The saving operation may be automatic or the user may press an appropriate button (not illustrated). The markings may be saved in a static format, such as by electronically copying the screen when the answer is input. In other embodiments the student markings may be saved in real-time, as the student interacts with the workspace 24. This saving method allows a reviewer, who may be the student, parent, or teacher, to view the student input as it was being created. In addition to presenting the problem in the area 146 of the screen, the area 146, or workspace 24, may include a changeable background image. In saving the real-time data, the saved data may be a moving image, or may include saving data, such as x-y position data, that may be used to re-create the image or a moving image.

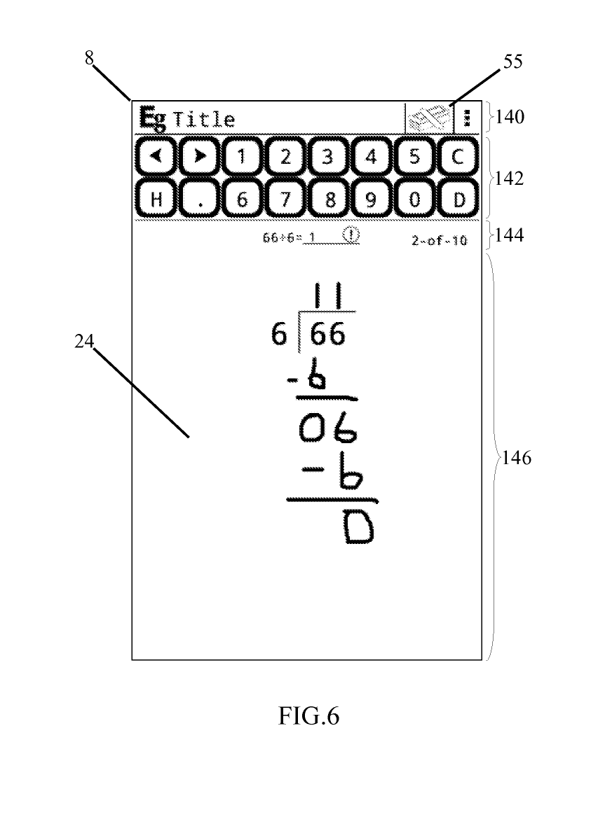

FIG. 6 illustrates an example of reworking a problem when the student had originally entered an incorrect answer. The reworking activity includes presenting a problem in the workspace 24 for the student to complete the problem by written hand, as well as a notification for the student to rework the problem. The notification may be an exclamation point in the area 144, for example. The notification may be generated in other ways, such as the system changing color of the screen of the touchscreen device 8 when the student enters a wrong answer, for example. Sounds may also be used as notifications or in conjunction with other notifications. Similar to the process described above, the student may draw or write over and around the problem statement, as well as use the rest of the available space in the area 146 to further work the problem out by hand all on a changeable background image.

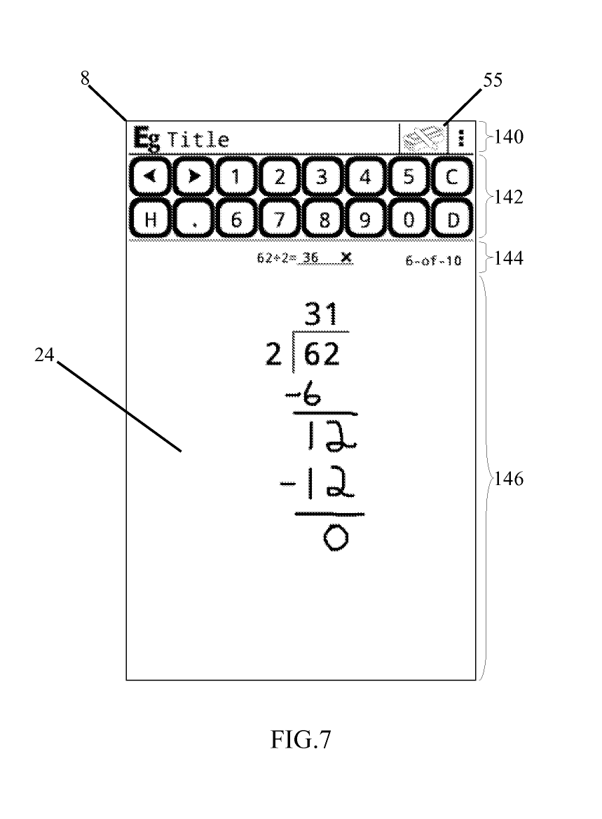

FIG. 7 illustrates that a student may correct a previous answer, for example where the student provided an incorrect answer to the stated problem more than once. In this operation, the answer may be provided for the student in the area 144 of the touchscreen device 8. Then, the student must enter the correct answer before continuing to the next problem in the session, or finishing the session.

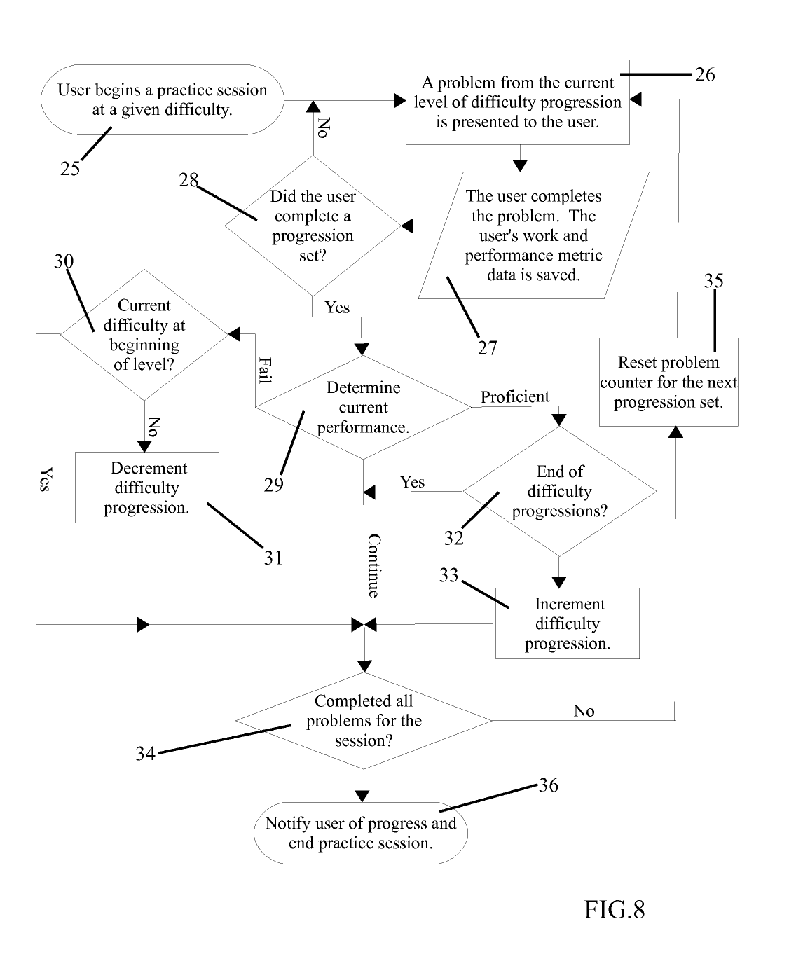

FIG. 8 illustrates example logic utilized in presenting problems to the user, including taking into consideration the academic subject progression of difficulty, according to embodiments of the invention. The process starts with the user beginning a previously set practice difficulty 25. A problem from the currently selected difficulty progression is presented to the user in an operation 26. When the user completes the problem, the handwritten work, i.e., the recorded touchscreen interaction, is saved in the form of a screenshot, and all applicable performance metrics are saved in an operation 27. In other embodiments the handwritten work is recorded as a set of multiple images in series, or the handwritten work may be stored by recording the address and timing of when the user touched the touchscreen. In this way, playback of the user's actual interaction may be saved for later recall. This cycle is repeated until the user completes all of the problems defined for the difficulty progression set. The number of problems is dependent on the progressions defined for the academic subject material. The application then compares the user's performance to the predefined difficulty standard in an operation 29. The difficulty level is adjusted based on the comparative results of the user's performance and the predefined acceptance criteria for the given difficulty level. If, for example, the user's performance is below expectation, the flow would exit the operation 29 in the “fail” direction. Then the application determines if it is already at the lowest, or beginning, level. If the application is not operating at the lowest level, and the student is not progressing well, then the difficulty of the progression is decremented in an operation 31. If instead the user's performance is at or above expectation, then the flow would exit the operation 29 in the “proficient” direction, and the current difficultly level assessed in comparison 32. If the application is not already operating at the highest difficulty level, then the difficulty level is raised in an operation 33. If the user has not completed all of the problems scheduled for the practice session, as determined by operation 34, he or she continues to practice the next difficulty progression set of problems; otherwise, the practice session is complete.

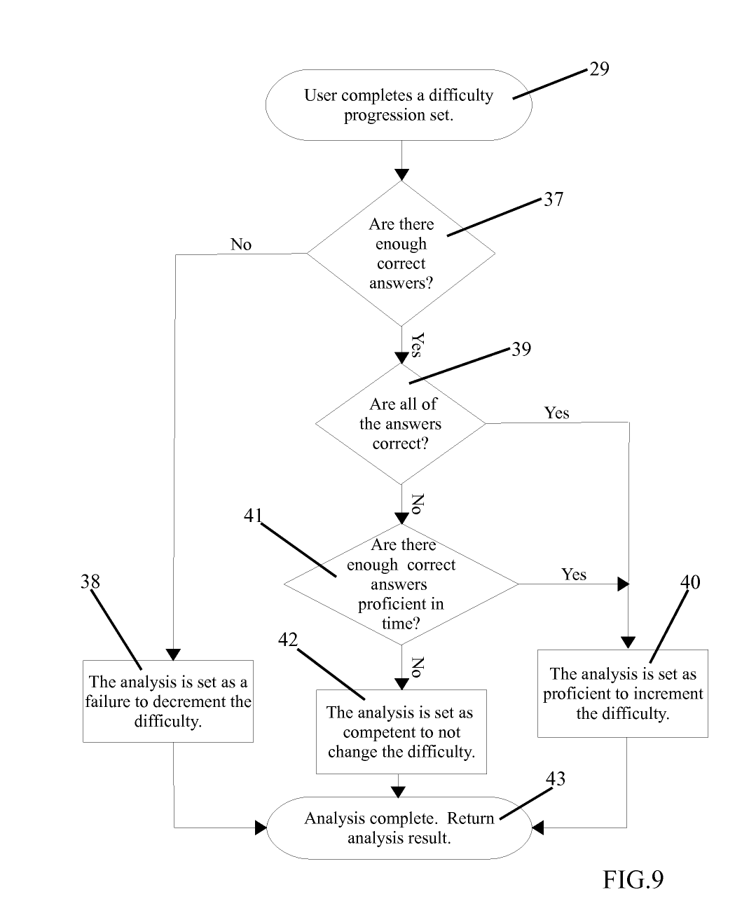

FIG. 9 illustrates example logic utilized to adjust a given difficulty setting according to embodiments of the invention. After completing a difficulty progression set of problems 29, the application determines if the completed set contains the minimum number of correct answers in an operation 37. If the minimum number of correct answers in the set was not reached, the set is defined as a failure in an operation 38. This failure will result in a decrease of difficulty, if applicable or possible. As determined in operations 39 and 41, if all answers in the set are correct, or at least the minimum number of proficient answers are provided, the set is defined as proficient in an operation 40. This will result in an increase of difficulty, if applicable; otherwise, the set is defined as competent in an operation 42, and the difficulty is not changed. Referring back to FIG. 8, when the user begins a practice session of a provided level of difficulty, he or she is presented with a problem from the current progression of difficulty in an operation 26. The user utilizes the touchscreen as a virtual piece of paper, and completes the provided problem by written hand, for example in the area 146 of the touchscreen device 8 (FIG. 5). When the user completes a problem, the written work is captured as a screenshot, or as a video, as described above, and all subject material defined performance metrics are gathered and saved in an operation 27 (FIG. 8). If the user misses an answer (FIG. 6), the student is notified to try again. Depending on the underlying subject material class, a hint may be presented to the user as to how to correctly answer the problem. Each time the user submits an answer, the written work is captured and all subject material defined performance metrics are gathered and saved. After a predetermined number of warnings, and or hints, the application determines an incorrect answer as wrong and presents the correct answer to the user (FIG. 7). The user is prompted to enter the correct answer to continue. When the user completes a progression set of problems in an operation 28 (FIG. 8), the application compares the collected performance metrics of the completed work against the qualification metrics of the progression set in a decision operation 29 (FIGS. 8 and 9). If the user did not complete enough correct answers, as determined by an operation 37 (FIG. 9), then the performance analysis is set as a failure in an operation 38. Instead, if the user completed all of the problems correctly based on the decision operation 39, or completed a previously specified number of problems correctly in a predetermined proficient qualification, as determined in a decision operation 41, then the analysis of the performance is set as proficient in an operation 40. Otherwise, the performance analysis is set to competent in an operation 42.

When the performance is determined as a failure in the decision operation 29 (FIG. 8), the application checks if the difficulty progression should be decremented in a decision operation 30. When the performance is determined as proficient in the decision operation 29, the application checks to determine if the difficulty progression should be incremented in the decision operation 32. In either case, or if the performance is determined as competent in decision operation and no adjustments are made, the application checks if the user has completed all of the problems they configured for the practice session in a decision operation 34. When there are additional problems to complete, the application resets the number of practiced progression set problems counter in operation 35, and presents the next problem to the user from the adjusted difficulty progression set in the operation 26. When all problems for a practice session are completed, a performance summary is provided and the session is ended in an operation 36. At any time during the practice session, the user may cancel the session and return to the welcome screen and activity selection (FIG. 1) 12.

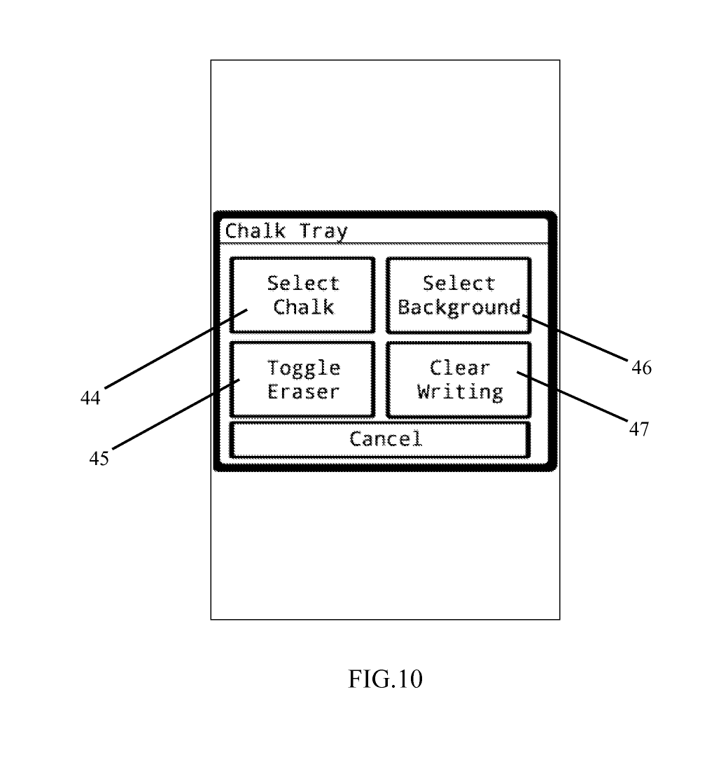

FIG. 10 is a screen shot of example drawing, or writing, options for the practice activity. The options include, for example, a drawing color and drawing line properties selection 44, an eraser mode 45, an option to change the background image of the practice activity 46, and an option to clear all user drawing and writing from the workspace 47.

Pressing a drawing option icon 55 (FIGS. 5, 6, and FIG. 7), while in a practice activity presents the user with the options (FIG. 10) of changing drawing color and other drawing line properties 44, toggling an eraser mode 45, changing the background image of the practice activity 46, and clearing all user drawing and writing on the workspace 47.

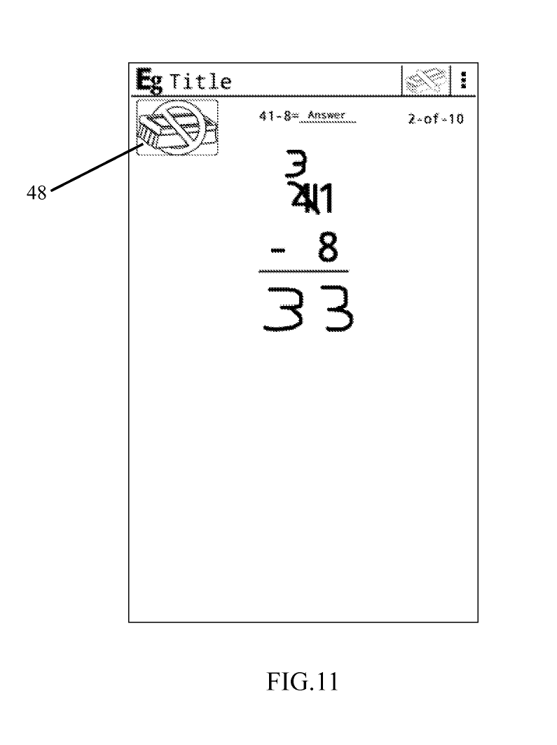

FIG. 11 is a screen shot illustrating an example practice activity when the eraser mode (45) is enabled. A cancel eraser mode option 48 is also presented to the user. The eraser mode removes previously written lines when the user moves the eraser near them. By selecting the eraser mode option 45 (FIG. 10), the focus, or present screen, is returned back to the workspace (FIG. 11) and an option to cancel the erase mode 48 is presented to the user. In some embodiments the eraser is “wider” than the drawing mode. In other words, it is easier to erase previous writing. The erase mode is disabled by selecting the cancel option 48, or by selecting the drawing options 55 and selecting the toggle erase mode option 45.

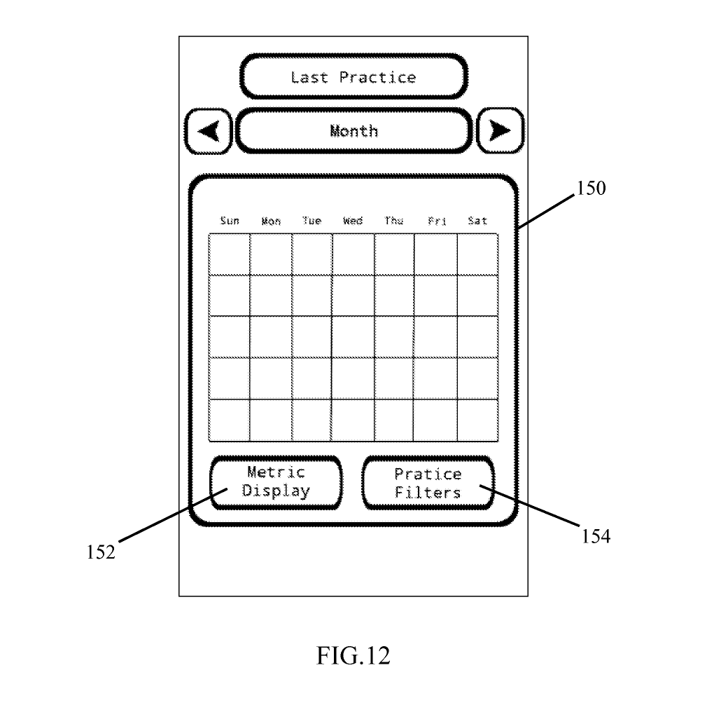

After completing at least one practice session, a review of the completed practice session may be performed in the reviewer activity 15 (FIG. 1). FIG. 12 is an example of the review of completed work activity screen. The example organizes completed practices in the form of a calendar. The review activity includes providing options for filtering the display of user performance metric summaries by pressing a button 152, as well as options to filter specific practices by pressing a filtering button 154.

Typically, practices are organized by time and date, and are reflected in a calendar 150 (FIG. 12).

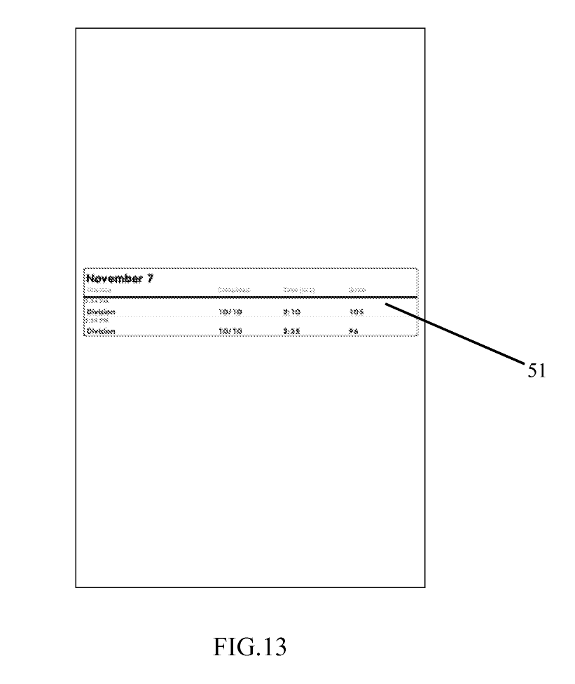

FIG. 13 illustrates an example of a list of filtered practice sessions for a selected date 51. With reference back to FIG. 12, pressing filtering button 154 of the calendar 150 brings options to filter which practices are highlighted in the calendar 150 and what summary of performance metrics to display are presented to the user. Days matching the selected filter options are highlighted in the calendar 150. Based on the selected filter options, when the user selects a highlighted day in the calendar 150, a list of matching practices is presented to the user in a list, such as the one illustrated in FIG. 13. There are, of course, multiple ways to show the raw data collected by the application.

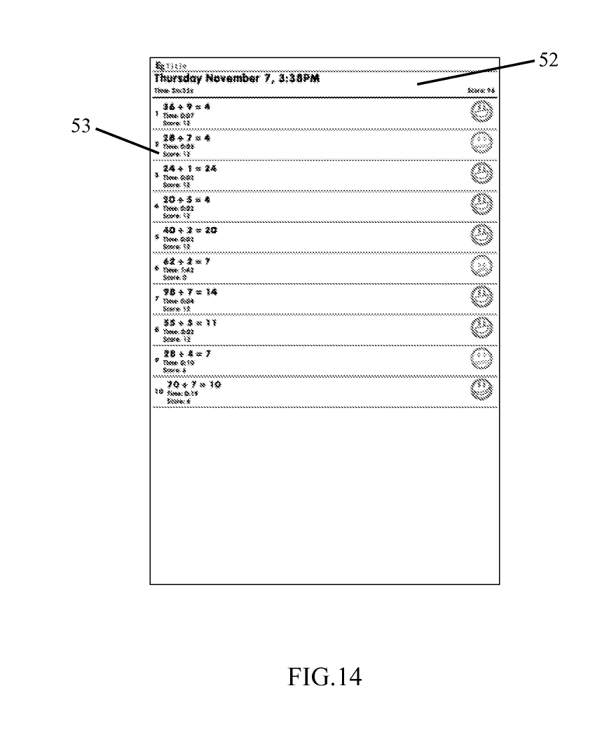

FIG. 14 is a screen shot of an example practice session review. The review is illustrated with a session summary field 52 and a presented problems list 53. Each problem is displayed with the user's final answer, collected metrics, and a user performance summary. The performance summary is represented in this example by a smiley graphic. An open mouth smiley face reflects proven proficiency in solving the stated problem. A smiley face reflects the user provided a correct answer on a first attempt, but did not meet the proficiency requirements in solving the problem. A flat line smiley face reflects that the user did not initially answer the problem correctly, but eventually was able to provide a correct answer. A face with a frown reflects that the user was unable to provide a correct answer for the provided problem. Of course, other performance summary feedback is possible, such as colors, pictures, icons, letter grades and raw or scaled scores. For instance, the proficiency may be presented as typical “A”, “B”, “C”, “D”, and “F” letter grades. Or, the proficiency may be presented as a scaled score between 1 and 10. The user may review his or her own work, or a reviewer, such as a parent or teacher, may review the work.

The display illustrated in FIG. 13 shows the selected date and the list of matching practices displaying the practice type, the time of day of the practice session, the time duration of the session, and other practice type specific metric data. When the user selects a particular practice from the filtered session list 51, the session review is presented (FIG. 14).

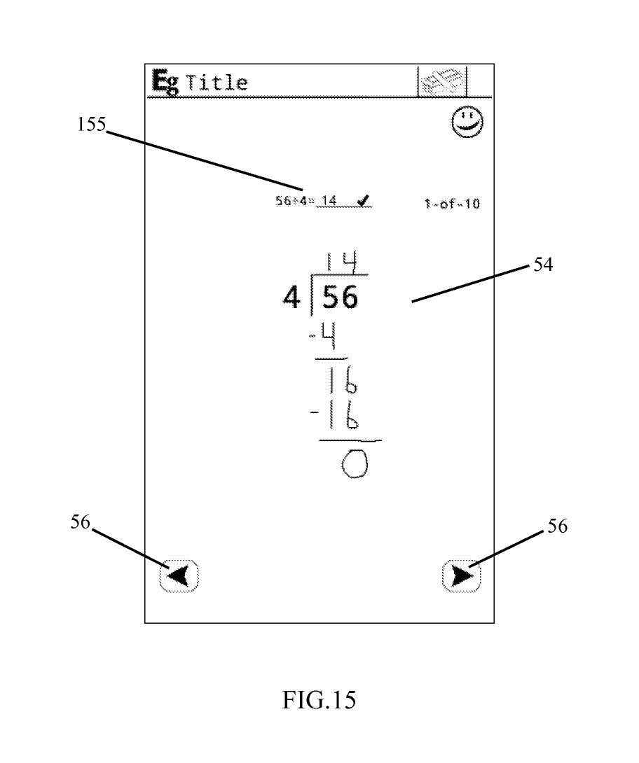

FIG. 15 is a screen shot illustrating an example of a practice session problem review. It consists of a screenshot of the user's work 54 and provided answer 155. The application filters out other items that may have been displayed during the actual practice session, such as the workspace background image, to simplify the image for review and reduce the storage size of the image. Arrow buttons 56 at the bottom of the screen, or a swipe gesture across the screen, causes the screen to scroll through the saved images of the user's work. As mentioned above, the user may review his or her own work, or a reviewer, such as a parent or teacher, may review the work.

All screenshots and performance metric data 53 (FIG. 14) and 54 (FIG. 15) are reviewable on a problem review screen. To view the review, the user selects the reviewer activity 20 from the welcome screen (FIG. 3).

In some embodiments, a reviewer, such as a teacher, may review the scholastic work on the same device that the user used to perform the practice set.

Although specific embodiments of the invention have been illustrated and described for purposes if illustration, it will be understood that various modifications may be made without departing from the spirit and scope of the invention. Accordingly, the invention should not be limited except as by the appended claims.

What is claimed is:

1. An interactive scholastic teaching device, comprising:
a touchscreen including:
a first portion of a touchscreen display for presenting one or more scholastic problems for a user during a problem session,
a second portion of the touchscreen display for recording one or more traces manually input by the user on the second portion of the touchscreen display during the problem session; and
a memory for storing the one or more traces of the user.

2. The scholastic teaching device according to claim 1 in which the touchscreen further includes a third portion having one or more touch buttons structured to accept input from the user during the problem session.

3. The scholastic teaching device according to claim 2 in which the memory is structured to store a record of touch buttons pressed by the user.

4. The scholastic teaching device according to claim 3 in which the memory is structured to store, for each problem within the problem session, the traces of the user associated with the record of touch buttons pressed by the user.

5. The scholastic teaching device of claim 1 in which the memory for storing the one or more traces of the user is structured to store an image.

6. The scholastic teaching device of claim 1 in which the memory for storing the one or more traces of the user is structured to store a moving image.

7. The scholastic teaching device of claim 1 in which at least one of the one or more scholastic problems is a math problem, a spelling problem, a geography problem, a history problem, a chemistry problem, a biology problem or a physics problem.

8. A method for performing scholastic training on a touch screen device, comprising:
presenting on a first portion of a display of the touch screen device one or more scholastic problems for a user during a problem session;
recording from a second portion of the display of the touch screen device one or more traces manually input by the user on the second portion of display during the problem session; and
storing in a memory of the touch screen device the one or more traces of the user.

9. The method according to claim 8, further comprising:
recording from a third portion of the display of the touch screen device one a state of one or more touch buttons selected by the user during the problem session.

10. The method according to claim 9, further comprising:
storing the recorded one or more states in the memory of the touch screen device.

11. The method according to claim 10, further comprising:
relating the stored traces of the user to the record of touch buttons pressed by the user.

12. The method according to claim 8, in which recording from a second portion of the display of the touch screen device one or more traces manually input by the user comprises storing an image.

13. The method according to claim 8, in which recording from a second portion of the display of the touch screen device one or more traces manually input by the user comprises storing a moving image.

14. The method according to claim 8, in which recording from a second portion of the display of the touch screen device one or more traces manually input by the user comprises storing data that may be recreated into a moving image.

15. A computer readable medium containing program instructions for causing a computing device to perform a method of for performing scholastic training on a touch screen device, the method comprising:
presenting on a first portion of a display of the touch screen device one or more scholastic problems for a user during a problem session;
recording from a second portion of the display of the touch screen device one or more traces manually input by the user on the second portion of display during the problem session; and
storing in a memory of the touch screen device the one or more traces of the user.

16. The computer readable medium of claim 15 in which the method further comprises:
recording from a third portion of the display of the touch screen device one a state of one or more touch buttons selected by the user during the problem session.

17. The computer readable medium of claim 16 in which the method further comprises:
storing the recorded one or more states in the memory of the touch screen device.

18. The computer readable medium of claim 15 in which the method further comprises:
relating the stored traces of the user to the record of touch buttons pressed by the user.

19. The computer readable medium of claim 15 in which recording from a second portion of the display of the touch screen device one or more traces manually input by the user comprises storing an image.

20. The computer readable medium of claim 15 in which recording from a second portion of the display of the touch screen device one or more traces manually input by the user comprises storing a moving image.

21. The computer readable medium of claim 15 in which recording from a second portion of the display of the touch screen device one or more traces manually input by the user comprises storing data that may be recreated into a moving image.
